(19) United States
(12) Patent Application Publication
(10) Pub. No.: US 2013/0183056 A1
(43) Pub. Date: Jul. 18, 2013

(54) FIXING DEVICE, IMAGE FORMING APPARATUS, FIXING METHOD, AND NON-TRANSITORY COMPUTER READABLE MEDIUM

(71) Applicants: Motofumi BABA, Kanagawa (JP); Hajime KISHIMOTO, Kanagawa (JP); Shuichi SUZUKI, Kanagawa (JP); Tsuyoshi SUNOHARA, Kanagawa (JP); Shinichi KINOSHITA, Kanagawa (JP); Takeo IWASAKI, Kanagawa (JP); Takashi ITO, Kanagawa (JP)

(72) Inventors: Motofumi BABA, Kanagawa (JP); Hajime KISHIMOTO, Kanagawa (JP); Shuichi SUZUKI, Kanagawa (JP); Tsuyoshi SUNOHARA, Kanagawa (JP); Shinichi KINOSHITA, Kanagawa (JP); Takeo IWASAKI, Kanagawa (JP); Takashi ITO, Kanagawa (JP)

(73) Assignee: FUJI XEROX CO., LTD., Tokyo (JP)

(21) Appl. No.: 13/591,850

(22) Filed: Aug. 22, 2012

(30) Foreign Application Priority Data
Jan. 17, 2012 (JP) 2012-007048

(51) Int. Cl. G03G 15/20

(52) U.S. Cl. 399/67; 399/329

(57) ABSTRACT

A fixing device includes a first rotation member, a fixing member, a determining unit, and a magnetic field generating unit. The first rotation member rotates around a first axis. The fixing member includes a second rotation member which rotates around a second axis while being in contact with the first rotation member, and which generates heat by using electromagnetic induction in an alternating-current magnetic field. The fixing member fixes an image onto a medium in a region where the first rotation member and the second rotation member come into contact with each other. The determining unit determines whether or not a current state is a certain state where the medium or an image formed on the medium is passing through the region. The magnetic field generating unit generates an alternating-current magnetic field in a space including the second rotation member.

### CROSS-REFERENCE TO RELATED APPLICATIONS

This application is based on and claims priority under 35 USC 119 from Japanese Patent Application No. 2012-007048 filed Jan. 17, 2012.

### BACKGROUND

### Technical Field

The present invention relates to a fixing device, an image forming apparatus, a fixing method, and a non-transitory computer readable medium.

### SUMMARY

According to an aspect of the invention, there is provided a fixing device including a first rotation member, a fixing member, a determining unit, and a magnetic field generating unit. The first rotation member rotates around a first axis. The fixing member includes a second rotation member which rotates around a second axis while being in contact with the first rotation member, the second axis extending along the first axis, and which generates heat by using electromagnetic induction in an alternating-current magnetic field. The fixing member fixes an image onto a medium in a region where the first rotation member and the second rotation member come into contact with each other. The determining unit determines whether or not a current state is a certain state where the medium or an image formed on the medium is passing through the region. The magnetic field generating unit generates an alternating-current magnetic field in a space including the second rotation member. In a case where plural media on which images have been formed intermittently pass through the region, the magnetic field generating unit generates an alternating-current magnetic field having a first intensity over a period in which the determining unit determines that the current state is the certain state, and generates an alternating-current magnetic field having a second intensity which is lower than the first intensity or does not generate an alternating-current magnetic field over a period in which the determining unit determines that the current state is not the certain state.

### BRIEF DESCRIPTION OF THE DRAWINGS

Exemplary embodiments of the present invention will be described in detail based on the following figures, wherein:

FIG. 1 is a block diagram illustrating a configuration of an image forming apparatus according to a first exemplary embodiment;

FIG. 2 is a diagram illustrating a configuration of an image forming section;

FIG. 3 is a diagram illustrating a configuration of a fixing device;

FIG. 4 is a diagram illustrating a cross section of the fixing device taken along line IV-IV of FIG. 3;

FIG. 5 is an enlarged diagram illustrating an X portion of a fixing belt;

FIG. 6 is a flowchart illustrating a procedure of a fixing process according to the first exemplary embodiment;

FIGS. 7A and 7B are graphs illustrating an example of the amount of current supplied to an exciting coil according to the first exemplary embodiment;

FIG. 8 is a flowchart illustrating a procedure of a fixing process according to a second exemplary embodiment;

FIGS. 9A to 9D are graphs illustrating the amount of supplied current according to the second exemplary embodiment;

FIGS. 10A to 10D are graphs illustrating the amount of supplied current according to a third exemplary embodiment;

FIGS. 11A to 11D are graphs illustrating the amount of supplied current according to a fourth exemplary embodiment;

FIG. 12 is a block diagram illustrating functions realized by a controller; and

FIGS. 13A and 13B are graphs illustrating examples of the relationship between the amount of supplied current and time according to a modification example.

### DETAILED DESCRIPTION

Hereinafter, exemplary embodiments of the present invention will be described with reference to the attached drawings.

### First Exemplary Embodiment

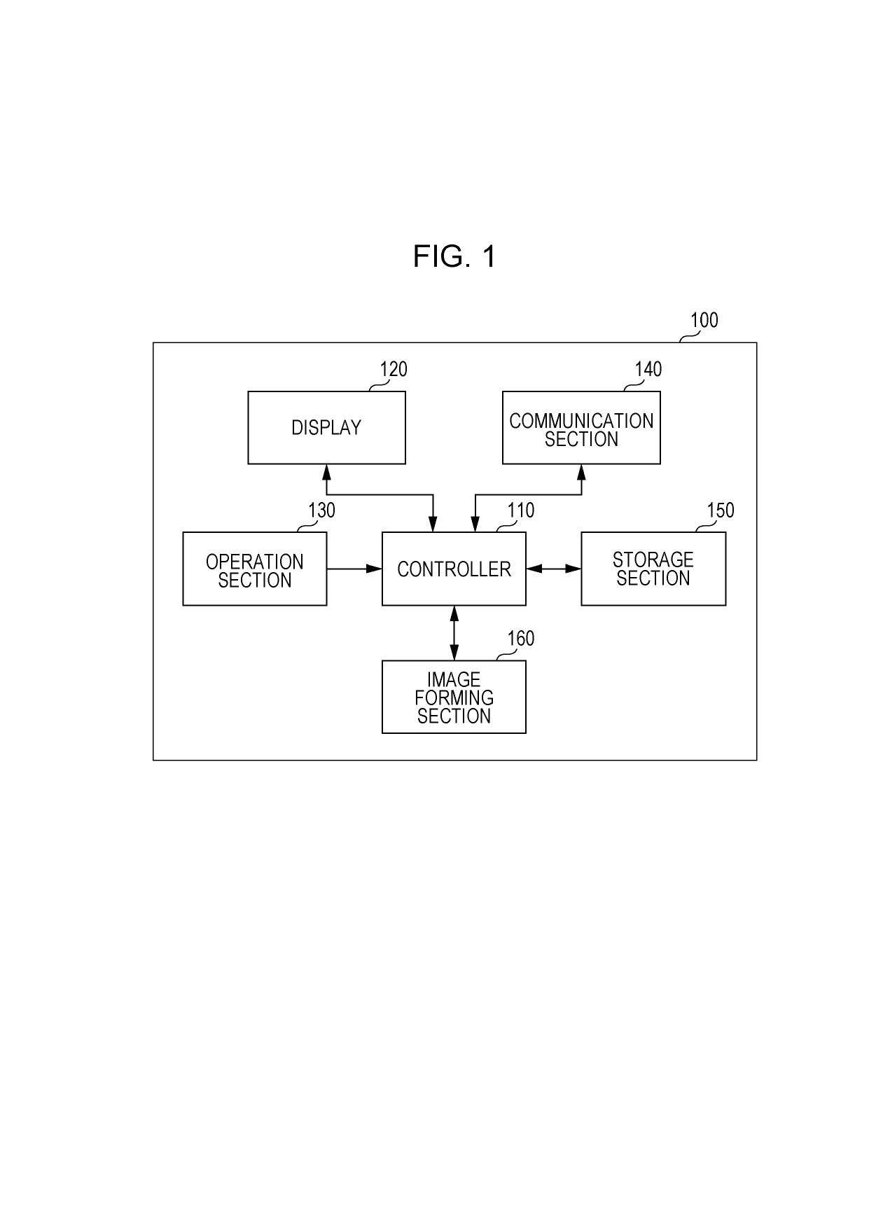

FIG. 1 is a block diagram illustrating a configuration of an image forming apparatus 100 according to a first exemplary embodiment. The image forming apparatus 100 forms an image corresponding to image data. The image forming apparatus 100 includes a controller 110, a display 120, an operation section 130, a communication section 140, a storage section 150, and an image forming section 160. The controller 110 is a computer including a processor, such as a central processing unit (CPU), and a memory. The processor of the controller 110 executes a program stored in the memory, so as to control the individual sections of the image forming apparatus 100 and process data. Also, the controller 110 has a function of measuring time, obtains a time when such control or process is performed, and performs such control or process at a determined time.

The display 120 includes a liquid crystal display screen and a liquid crystal drive circuit, and displays progress information regarding a process, information for guiding a user performing an operation, and so forth in accordance with information supplied from the controller 110. The operation section 130 includes an operator, such as a button, and supplies the controller 110 with operation information representing the details about an operation performed by a user. The communication section 140 connects to a communication line, such as a local area network (LAN), and communicates with an external apparatus connected to the communication line. The communication section 140 receives, from the external apparatus, request data representing a request for forming an image on a sheet, together with image data to be used for forming the image. The communication section 140 supplies the received data to the controller 110. The storage section 150 includes a storage device such as a hard disk drive (HDD), and stores, for example, the above-described image data. The image forming section 160 forms an image on a sheet serving as a recording medium by using an electrophotographic system and toners of four colors including yellow (Y), magenta (M), cyan (C), and black (K).

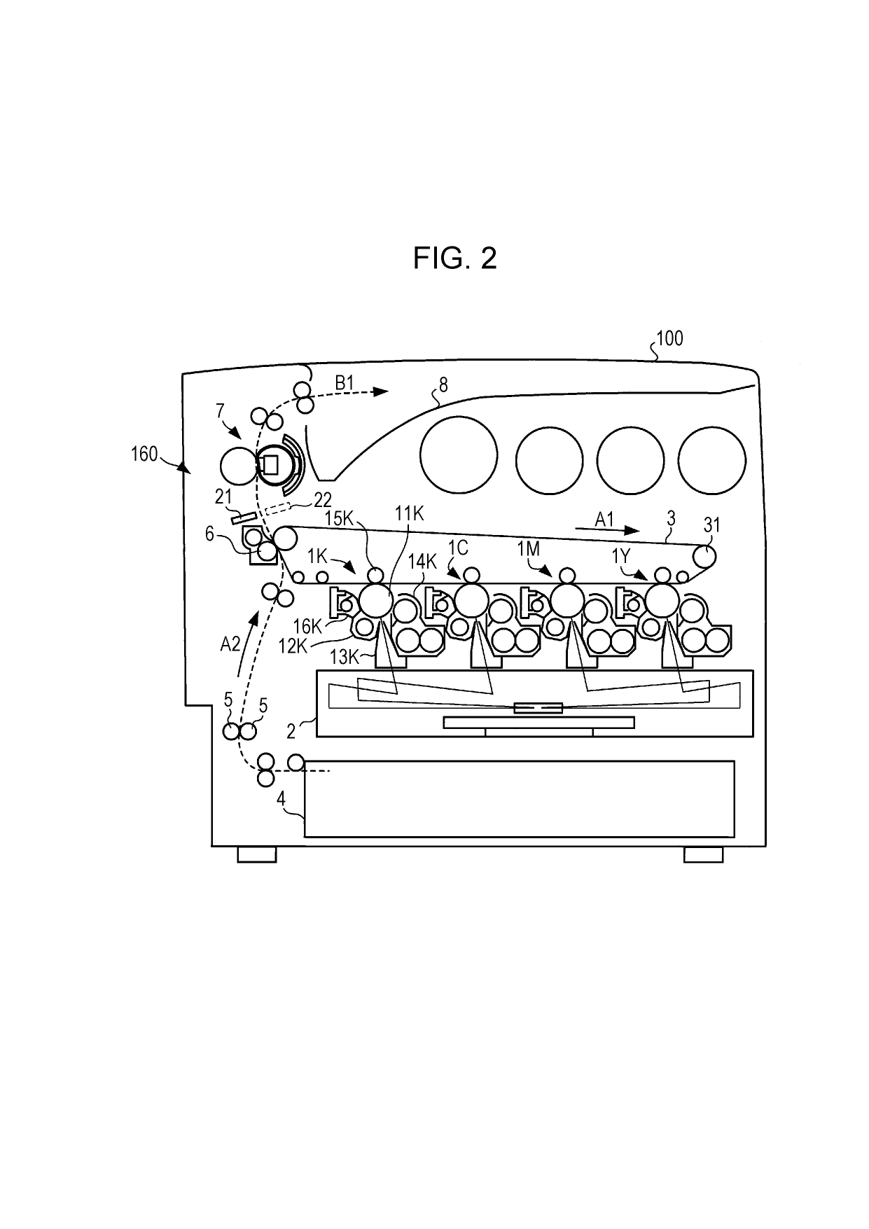

FIG. 2 is a diagram illustrating a configuration of the image forming section 160. In the reference numerals assigned to the elements of the image forming section 160 illustrated in FIG. 2, an alphabetic character attached to the end of a reference numeral represents the color of toner used in the image forming apparatus 100. The elements denoted by the same reference numerals with different alphabetic characters handle toners of different colors, but the configurations thereof are the same. Hereinafter, description will be given by omitting the alphabetic characters at the end of reference numerals when it is not necessary to distinguish such elements from one another. The image forming section 160 includes image forming units 1Y, 1M, 1C, and 1K, an exposure device 2, an intermediate transfer belt 3, a paper feeder 4, plural transport rollers 5, a second transfer roller 6, a fixing device 7, an output unit 8, and a sheet sensor 21.

The exposure device 2 emits light (exposure light) corresponding to image data for individual colors to the individual image forming units 1, so as to form electrostatic latent images serving as a base of images of the individual colors. The image forming units 1Y, 1M, 1C, and 1K develop the electrostatic latent images by using toners, and thereby form images of the individual colors. The configuration of these image forming units 1 will be described. Here, the configuration of the image forming unit 1K will be described. The image forming unit 1K includes a photoconductor 11K, a charging device 12K, an exposure unit 13K, a developing device 14K, a first transfer roller 15K, and a cleaning device 16K. The photoconductor 11K is a cylindrical member which has a photoconductive film stacked on its surface and which rotates around the axis, and holds an electrostatic latent image formed on its surface.

The charging device 12K causes the photoconductor 11K to be charged at a determined charging potential. The exposure unit 13K forms a path for exposure light which is output from the exposure device 2 and reaches the photoconductor 11K. The exposure light emitted from the exposure device 2 reaches the surface of the photoconductor 11K, which is charged by the charging device 12K, via the exposure unit 13K. Accordingly, an electrostatic latent image corresponding to image data is formed on the surface of the photoconductor 11K. The developing device 14K accommodates a developer including toner, which is a non-magnetic substance, and a carrier, which is a magnetic substance. The developing device 14K supplies the toner included in the developer to the above-described electrostatic latent image, develops the electrostatic latent image, and thereby forms an image on the surface of the photoconductor 11K. The first transfer roller 15K performs a first transfer process of transferring the image from the photoconductor 11K onto the intermediate transfer belt 3. The cleaning device 16K removes toner remaining on the surface of the photoconductor 11K after the first transfer process.

The intermediate transfer belt 3 is wound around plural rollers including a drive roller 31, and is rotatably supported by these rollers. The drive roller 31 is driven by a driving mechanism (not illustrated) which is controlled by the controller 110, so as to rotate at a rotation speed determined by the controller 110. The intermediate transfer belt 3 rotates in a rotation direction A1 indicated by an arrow illustrated in FIG. 2, along with the rotation of the drive roller 31. Images formed by the individual image forming units 1 are transferred in a superimposed manner onto the outer surface of the intermediate transfer belt 3. The paper feeder 4 accommodates plural sheets of paper.

The plural transport rollers 5 serve as a transport member that forms a transport path B1, which is represented by a broken-line arrow extending from the paper feeder 4 to the output unit 8 via the second transfer roller 6 and the fixing device 7, and that transports a sheet along the transport path B1 in a transport direction A2 indicated by an arrow illustrated in FIG. 2. These transport rollers 5 are driven by a driving mechanism (not illustrated) which is controlled by the controller 110, so as to rotate at a rotation speed determined by the controller 110. The second transfer roller 6 is in contact with the intermediate transfer belt 3, so as to form a transfer region, which is a region for transferring an image. The second transfer roller 6 performs a second transfer process of transferring, onto a sheet transported to the transfer region by the plural transport rollers 5, an image which has been transferred onto the intermediate transfer belt 3 in a first transfer process. Accordingly, the image is formed on the sheet. The above-described image forming units 1, exposure device 2, intermediate transfer belt 3, and second transfer roller 6 serve as a section for forming an image on a sheet, and correspond to an example of an “image forming section” according to an exemplary embodiment of the invention. The second transfer roller 6 is driven by a driving mechanism (not illustrated) which is controlled by the controller 110, so as to rotate at a rotation speed determined by the controller 110. A sheet that has passed through the transfer region is transported along the transport path B1 to the fixing device 7.

The fixing device 7 applies heat and pressure to an image which has been transferred onto a transported sheet in a second transfer process, and thereby fixes the image onto the sheet. The timing to apply heat by the fixing device 7 is controlled by the controller 110 illustrated in FIG. 1. The fixing device 7 and the controller 110 operate in conjunction with each other, thereby functioning as a “fixing device” according to an exemplary embodiment of the invention. The sheet on which the image has been formed is transported by the plural transport rollers 5 and is output to the output unit 8.

The transport speed of a sheet is determined depending on the rotation speeds of the plural transport rollers 5, the intermediate transfer belt 3, and the second transfer roller 6. These rotation speeds are determined by the controller 110, as described above. That is, the controller 110 determines the rotation speeds, and thereby controls the transport speed of a sheet in a range from 150 mm per second to 200 mm per second. Specifically, the controller 110 supplies a control signal corresponding to a transport speed to each of the above-described driving mechanisms, and thereby controls the driving mechanisms so that the sheet is transported at the transport speed.

The sheet sensor 21 senses whether or not a sheet exists at a certain position of the transfer path B1. Hereinafter, the position where the sheet sensor 21 senses whether or not a sheet exists is referred to as a “sheet sensing position”. The sheet sensor 21 is disposed so that the sheet sensing position is located in the range from the transfer region to the fixing device 7 along the transport path B1. The sheet sensor 21 is an optical sensor or the like, emits light to the sheet sensing position, and receives light from the sheet sensing position. The intensity of light received by the sheet sensor 21 varies depending on whether or not a sheet exists at the sheet sensing position. For example, it is sensed that a sheet exists at the sheet sensing position if the intensity is equal to or higher than a certain threshold, and it is sensed that no sheet exists at the sheet sensing position if the intensity is lower than the certain threshold. The sheet sensor 21 supplies sensing data, which represents a sensing result, to the controller 110. The sensing data is, for example, data representing the intensity of received light. The controller 110 determines that a sheet exists at the sheet sensing position if the intensity represented by the sensing data is equal to or higher than the foregoing threshold, and determines that no sheet exists at the sheet sensing position if the intensity is lower than the threshold.

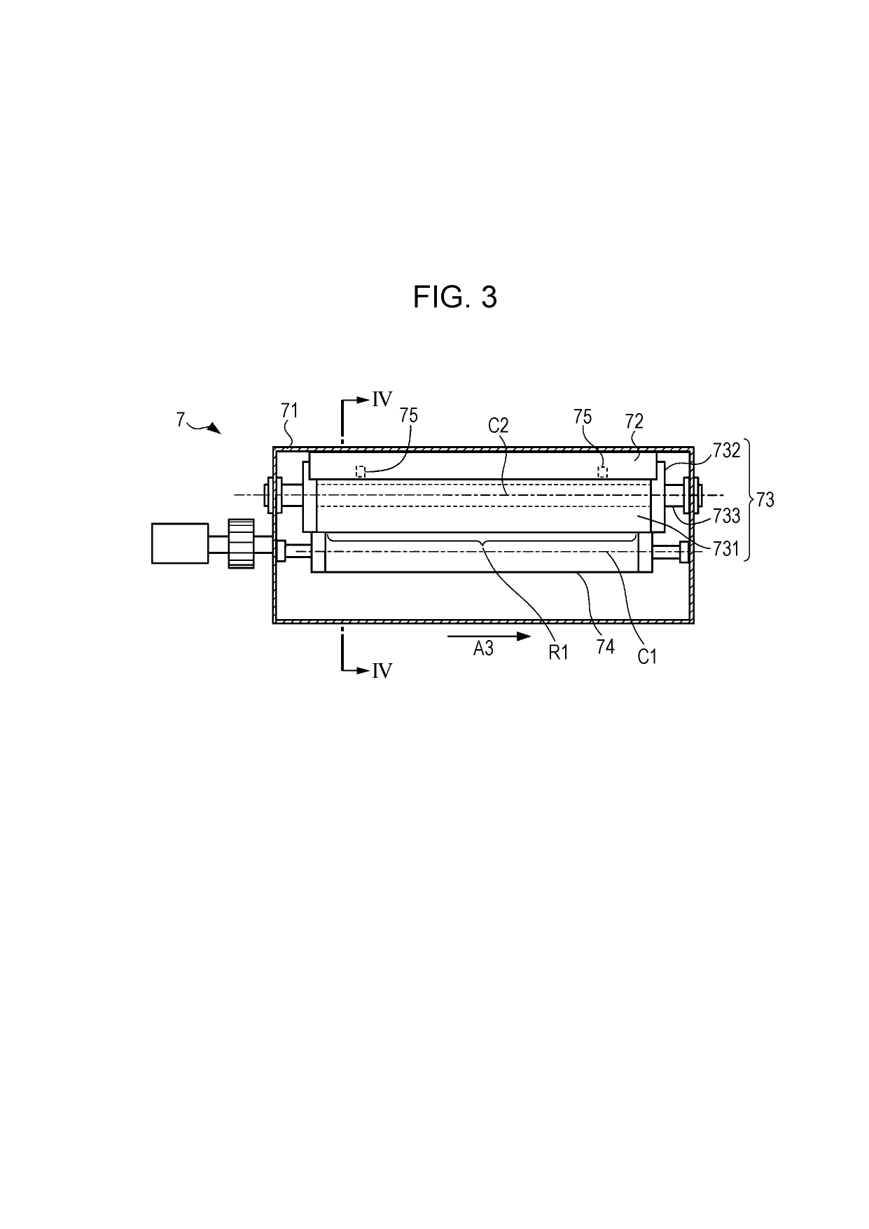

FIG. 3 is a diagram illustrating a configuration of the fixing device 7. FIG. 3 illustrates the fixing device 7 viewed from a sheet transport side. The fixing device 7 includes a support body 71, which accommodates an induction heating (IH) heater 72, a fixing member 73, and a pressure roller 74. The pressure roller 74 rotates around an axis C1 represented by a dotted chain line, and is rotatably supported by the support body 71. The axis C1 extends along an axis direction A3 indicated by an arrow. The pressure roller 74 is moved into contact with and away from the fixing member 73 by a contact and separation mechanism (not illustrated). FIG. 3 illustrates a state where the pressure roller 74 is in contact with the fixing member 73. In this state, the fixing member 73 and the pressure roller 74 form a nip region R1. The nip region R1 is a region through which a sheet passes.

The IH heater 72 generates an alternating-current magnetic field in a space including the fixing member 73, upon being supplied with power. The fixing member 73 fixes an image onto a sheet in the nip region R1. The fixing member 73 includes a fixing belt 731, a belt support member 732, and a holder 733. The fixing belt 731 is an endless belt formed in a cylindrical shape, and the outer surface thereof comes into contact with the pressure roller 74 to form the nip region R1. The fixing belt 731 generates heat by using electromagnetic induction caused by an alternating-current magnetic filed generated by the IH heater 72. The fixing belt 731 applies heat, which is generated in this manner, to a sheet passing through the nip region R1, and thereby fixes an image formed on the sheet onto the sheet. In the fixing device 7, the temperature of the fixing belt 731 for fixing an image is preset, which is referred to as “fixing temperature”. The holder 733 is a bar-like member that extends in the axis direction A3, and the both ends thereof in the axis direction A3 are fixed to the support body 71. The belt support member 732 supports the both ends in the axis direction A3 of the fixing belt 731 while keeping the shape of a cross section of the fixing belt 731 circular. The belt support member 732 is supported by the holder 733 so as to be rotatable around the axis of the fixing belt 731, and is rotated by a driving mechanism (not illustrated) in the rotation direction of the fixing belt 731. Accordingly, the fixing belt 731 rotates around an axis C2 represented by a dotted chain line. Like the axis C1, the axis C2 extends along the axis direction A3. The axis C1 is an example of a “first axis” according to an exemplary embodiment of the invention, and the axis C2 is an example of a “second axis” according to an exemplary embodiment of the invention.

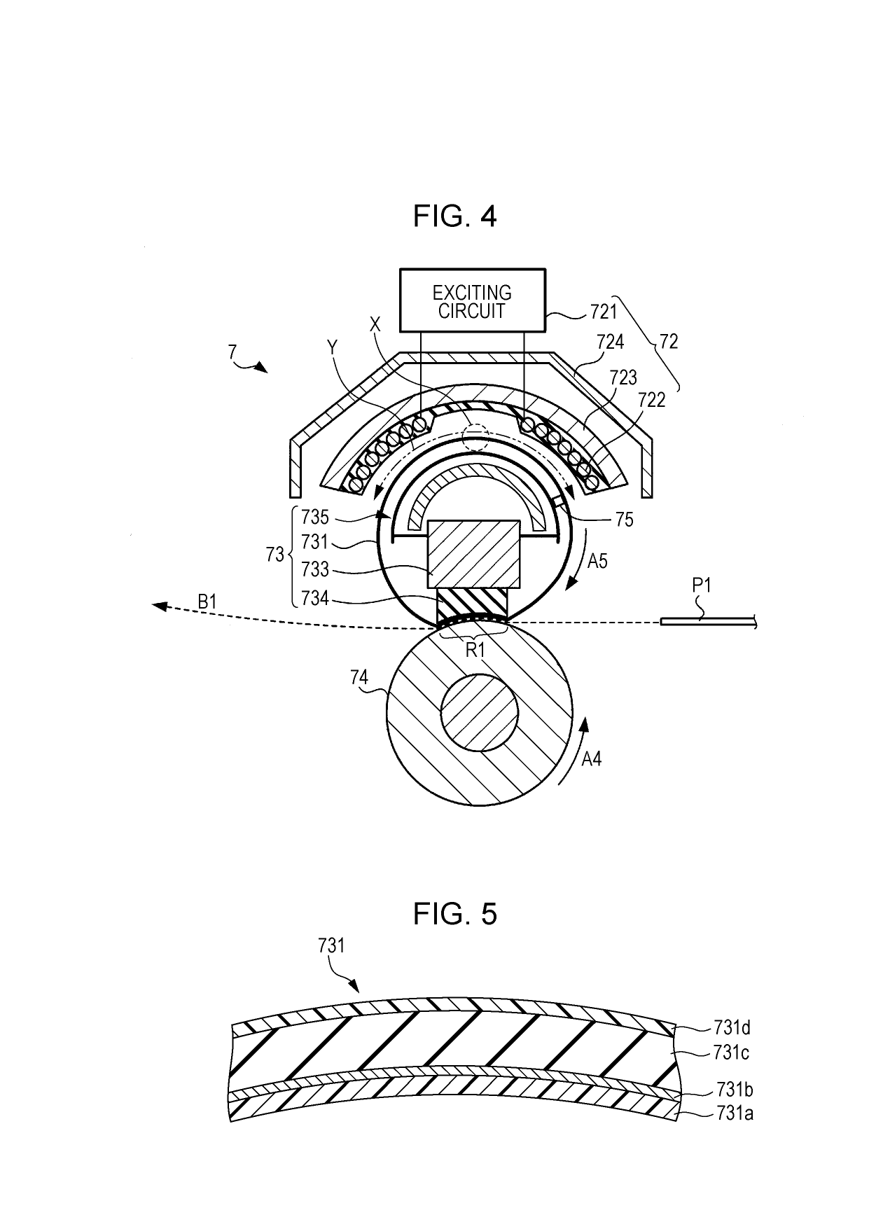

FIG. 4 is a diagram illustrating the cross section of the fixing device 7 taken along line IV-IV of FIG. 3. In FIG. 4, the support body 71 is not illustrated. The IH heater 72 includes an exciting circuit 721, an exciting coil 722, a magnetic core 723, and a shield 724. The exciting circuit 721 supplies an alternating current of a determined frequency to the exciting coil 722. This frequency is, for example, a frequency of an alternating current generated by a general-purpose power supply, and is 20 kHz or more and 100 kHz or less, for example. The amount of the alternating current is controlled by the controller 110. The exciting coil 722 is formed by winding a Litz wire, which is a bundle of copper wires insulated from one another, in the shape of an oval or rectangular closed loop with a hollow space at the center. When the above-described alternating current is supplied from the exciting circuit 721 to the exciting coil 722, an alternating-current magnetic field centered on the Litz wire is generated around the exciting coil 722. The intensity of the alternating-current magnetic field increases as the amount of the current increases.

The magnetic core 723 is an arc-shaped ferromagnetic body made of a material such as a fired ferrite, a ferrite resin, Permalloy, or a temperature-sensitive magnetic alloy. These materials are oxides or alloys having a relatively high magnetic permeability. The magnetic core 723 induces, thereinto, magnetic lines of force (magnetic flux) of the alternating-current magnetic field generated around the exciting coil 722, and forms paths of the magnetic lines of force (magnetic paths) which extend from the magnetic core 723, pass through the fixing member 73, and return to the magnetic core 723 from an induction member 735, which is made of a ferromagnetic body like the magnetic core 723. As a result of forming the magnetic paths between the magnetic core 723 and the induction member 735 made of a ferromagnetic body, the magnetic lines of force of the above-described alternating-current magnetic field are concentrated at a portion facing the magnetic core 723 of the fixing member 73. Accordingly, a magnetic field with a high magnetic flux density may be formed, and high-efficiency induction heating may be realized. The shield 724 shields a magnetic field to suppress leakage thereof to the outside.

The fixing member 73 includes a pad 734 and the induction member 735, in addition to the above-described fixing belt 731 and holder 733. The fixing belt 731 comes into contact with the pressure roller 74 to form the nip region R1, as described above. A sheet P1 is transported to the nip region R1 along the transport path B1 by the plural transport rollers 5 illustrated in FIG. 2. The plural transport rollers 5 serve as a member for transporting a sheet on which an image has been formed to the nip region R1, and correspond to a “transport member” according to an exemplary embodiment of the invention. The pressure roller 74 rotates in a rotation direction A4 indicated by an arrow. The fixing belt 731 rotates in a rotation direction A5 indicated by an arrow. When the pressure roller 74 and the fixing belt 731 rotate in these directions, the sheet P1 which has been transported to the nip region R1 passes through the nip region R1 and is transported along the transport path B1. The pressure roller 74 is an example of a “first rotation member” according to an exemplary embodiment of the invention, and the fixing belt 731 is an example of a “second rotation member” according to an exemplary embodiment of the invention. A specific configuration of the fixing belt 731 will be described below with reference to FIG. 5.

FIG. 5 is an enlarged diagram illustrating an X portion of the fixing belt 731. The fixing belt 731 includes a base layer 731a, a conductive heat-generating layer 731b, an elastic layer 731c, and a surface release layer 731d. The base layer 731a is formed of a heat-resistant sheet-like member, supports the conductive heat-generating layer 731b, and forms a mechanical strength of the entire fixing belt 731. The base layer 731a is formed by using a material and thickness having properties (relative magnetic permeability and specific resistance) for allowing a magnetic field to pass therethrough. The base layer 731a does not generate heat in response to a magnetic field, or is less likely to generate heat than the conductive heat-generating layer 731b. The base layer 731a is made of, for example, a non-magnetic metal, such as non-magnetic stainless steel, having a thickness of 30 μm or more and 200 μm or less, or a resin material having a thickness of 60 μm or more and 200 μm or less.

The conductive heat-generating layer 731b is made of, for example, a non-magnetic metal, such as Au, Ag, or Cu, or a metal alloy of these metals, and has a thickness of 2 or more and 20 μm or less. These materials are paramagnetic materials having a relative magnetic permeability of about one, and the specific resistance thereof is 2.7×10−8 Ω·m or less. When an alternating-current magnetic field generated by the IH heater 72 passes through the conductive heat-generating layer 731b in the thickness direction thereof, electromagnetic induction occurs and an eddy current flows inside the conductive heat-generating layer 731b. The flow of the eddy current causes the conductive heat-generating layer 731b to generate heat. In this way, the conductive heat-generating layer 731b is heated by an alternating-current magnetic field generated by the IH heater 72. Hereinafter, heat generation or heating in the fixing belt 731, which includes the conductive heat-generating layer 731b, caused by electromagnetic induction in an alternating-current magnetic filed is referred to as “electromagnetic induction heating”.

The elastic layer 731c is made of a material which is deformed when pressure is applied thereto and which is restored when the application of pressure is stopped, such as silicone rubber. For example, the elastic layer 731c is made of silicone rubber having a hardness of 10° or more and 30° or less (JIS-A) and has a thickness of 100 μm or more and 600 μm or less. An image which has been transferred onto a sheet by the above-described second transfer roller 6 through a second transfer process is formed of a stack of color toners, which are powder, and thus has minute bumps and hollows. The elastic layer 731c is deformed in accordance with such bumps and hollows of the image. If the fixing member 73 is not deformed, variation may occur in the amount of heat supplied to a portion of an image which comes into contact with the fixing member 73 and the amount of heat supplied to a portion of the image which does not come into contact with the fixing member 73, and unevenness may occur in the degree of fixing of the image. The deformation of the elastic layer 731c reduces such unevenness.

The surface release layer 731d comes into direct contact with an image (toner) formed on a sheet, and is thus more appropriate as the releasability thereof for toner is higher. The surface release layer 731d is made of a material having a relatively high releasability for toner, such as tetrafluoroethylene-perfluoroalkylvinylether copolymer (PFA), polytetrafluoroethylene (PTFE), silicone copolymer, or a composite layer made of these materials. As the thickness of the surface release layer 731d decreases, the time period until the surface release layer 731d loses its function as a release layer due to a reduction in thickness of the layer caused by abrasion becomes shorter, that is, the life of the fixing belt 731 becomes shorter. On the other hand, as the thickness of the surface release layer 731d increases, the heat capacity of the fixing belt 731 increases, and the time period until the fixing belt 731 is heated to reach a determined temperature becomes longer. The surface release layer 731d has a thickness of 1 μm or more and 50 μm or less so that the above-described life and time period are within a determined range.

Referring back to FIG. 4, the pad 734 is made of a material which is deformed by pressure, such as silicone rubber or fluororubber, and is disposed at a position which is on an inner side of the fixing belt 731 and which faces the pressure roller 74. The pad 734 supports the fixing belt 731 pressed by the pressure roller 74 in the nip region R1. The holder 733 is made of, for example, a heat-resistant resin, such as glass-filled polyphenylene sulfide (PPS), or a non-magnetic metal, such as Au, Ag, or Cu. Accordingly, the holder 733 is less likely to affect an induced magnetic field and is less likely to be affected by the induced magnetic field than in the case of using another material.

The induction member 735 is arc-shaped along the inner surface of the fixing belt 731 and is made of a ferromagnetic material. In the first exemplary embodiment, the induction member 735 is made of a temperature-sensitive magnetic alloy, and is disposed on the inner side of the fixing belt 731 while being supported by the holder 733. The induction member 735 forms magnetic paths for inducing, thereinto, magnetic lines of force that have been generated by the IH heater 72 and that have passed through a portion of the fixing belt 731, and for causing the magnetic lines of force to return to the IH heater 72. With the magnetic paths, electromagnetic induction occurs in a portion in the range indicated by an arrow of a double-dotted chain line of the fixing belt 731, and heat is generated in this portion. Hereinafter, this range is referred to as a heating range Y. In this way, an alternating-current magnetic field is generated by the IH heater 72 in a space including a portion of the fixing belt 731, that is, a portion in the heating range Y. The induction member 735 is disposed with a gap of a predetermined length (for example, 0.5 mm or more and 1.5 mm or less) with respect to the inner surface of the fixing belt 731. With this structure, when the fixing belt 731 is heated, flow of the heat of the fixing belt 731 into the induction member 735 may be suppressed compared to a case where such a gap is not formed, a warm-up time may be shortened, and very quick startup may be realized.

Two temperature sensors 75 are provided in the gap between the induction member 735 and the fixing belt 731. As illustrated in FIG. 3, the temperature sensors 75 are provided at two different positions along the above-described axis direction A3. As illustrated in FIG. 4, the temperature sensors 75 are fixed at an end on the downstream side in the rotation direction A5 of the heating range Y, that is, at the position where heating of the fixing belt 731 ends, so as to be in contact with the inner surface of the fixing belt 731. Accordingly, the temperature sensors 75 measure the temperature of a portion of the fixing belt 731 at which heating by the IH heater 72 substantially ends. The temperature sensors 75 supplies data representing the measured temperature to the controller 110 illustrated in FIG. 1.

When the image forming apparatus 100 receives a request for forming images on plural sheets, the sheets transported to the fixing device 7 intermittently pass through the nip region R1. In this case, in the image forming apparatus 100, the controller 110 controls the individual sections to perform a fixing process (a process of fixing an image onto a sheet) such that the amount of current supplied from the exciting circuit 721 to the exciting coil 722 is reduced when no sheet is passing through the nip region R1, that is, when fixing of an image onto a sheet is not being performed.

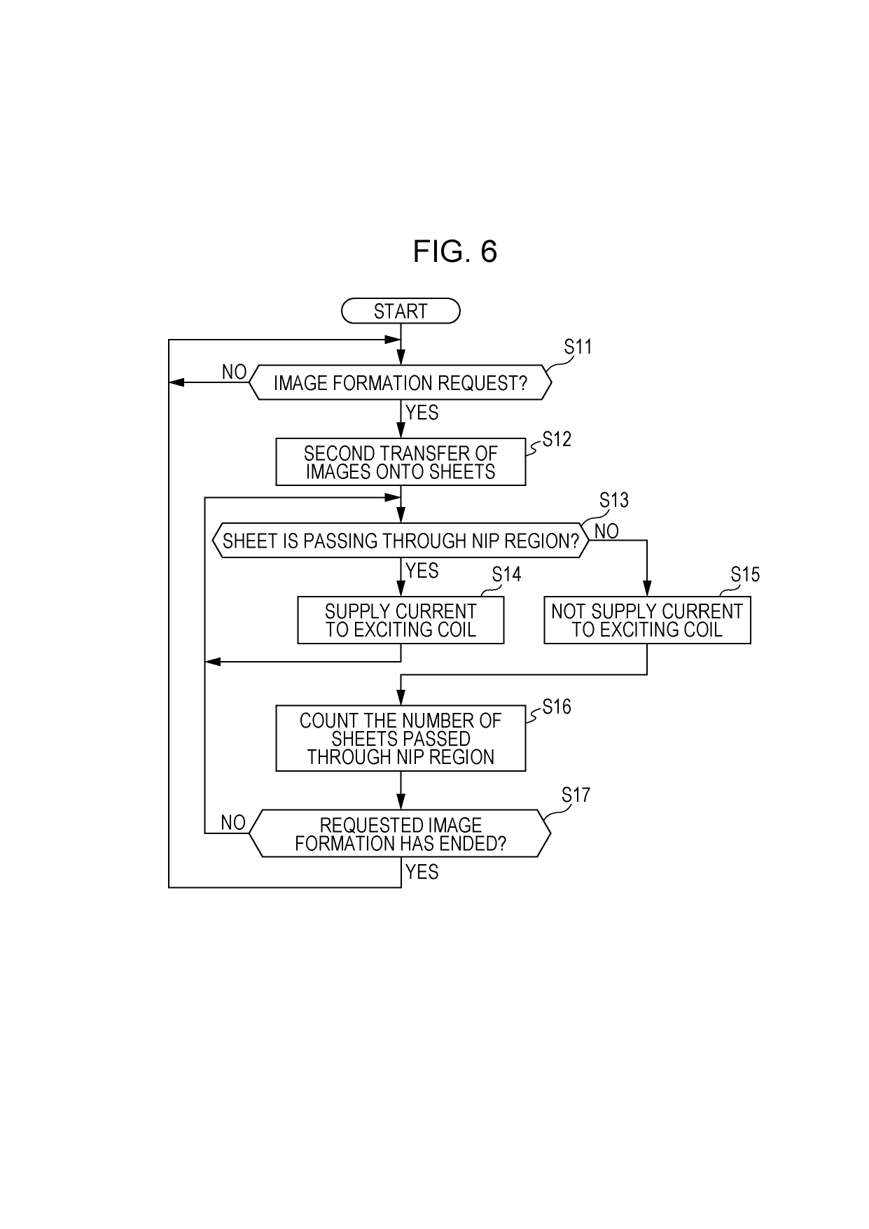

FIG. 6 is a flowchart illustrating a procedure of the fixing process. This process is started after the power of the image forming apparatus 100 has been turned on. In step S11, the controller 110 determines whether or not an image formation request has been received from an external apparatus. Specifically, if the above-described request data and image data have been supplied via the communication section 140, the controller 110 determines that the request has been received (YES). If the request data and image data have not been supplied, the controller 110 determines that the request has not been received (NO). Hereinafter, description will be given under the assumption that the image data represents plural images and that these images are to be formed on respective sheets. If the controller 110 determines that the request has not been received (NO), the controller 110 performs step S11 again, and repeats this step until it receives the request. If the controller 110 determines that the request has been received (YES), the controller 110 controls the individual units of the image forming section 160, so as to form the images represented by the transmitted image data on the intermediate transfer belt 3, transport sheets from the paper feeder 4 to the transfer region, and transfer the images onto the sheets in a second transfer process in step S12. This process is sequentially performed on the plural images represented by the image data. Accordingly, the sheets on which the images have been formed, the number of sheets corresponding to the number of images represented by the image data, are intermittently transported to the nip region R1.

In step S13, the controller 110 determines whether or not a sheet is passing through the nip region R1. Hereinafter, a state where a sheet is passing through the nip region R1 is referred to as a “passing state”. The passing state is an example of a “certain state” according to an exemplary embodiment of the invention. The controller 110 performs the determination by using sensing data supplied from the sheet sensor 21. In order to perform the determination, the storage section 150 stores a first distance and a second distance in advance. The first distance is a distance along the transport path B1 between the nip region R1 and the sheet sensing position where the sheet sensor 21 senses whether or not there is a sheet. The second distance is the sum of the first distance and the distance of the nip region R1 along the transport path B1. First, the controller 110 repeatedly determines, at certain intervals (for example, at the intervals of 1 msec), whether or not there is a sheet at the sheet sensing position by determining whether or not the intensity of light represented by sensing data is equal to or higher than a threshold. When receiving a sensing result indicating that there is a sheet, the controller 110 determines that the front end of the sheet in the transport direction A2 has reached the sheet sensing position. After that, when receiving a sensing result indicting that there is no sheet, the controller 110 determines that the rear end of the sheet in the transport direction A2 has reached the sheet sensing position.

The controller 110 obtains, when the front end and the rear end of a sheet are sensed, the times when the front end and the rear end are sensed. These times are referred to as a front end sensing time and a rear end sensing time, respectively. The controller 110 adds, to the obtained front end sensing time, the time obtained by dividing the first distance by the currently controlled transport speed. The time obtained through the addition corresponds to the time when the sheet reaches the nip region R1 (hereinafter referred to as “arrival time”). The time added here corresponds to the time period until the front end of the sheet transported at this transport speed reaches the nip region R1. Also, the controller 110 adds, to the obtained rear end sensing time, the time obtained by dividing the second distance by the currently controlled transport speed. The time obtained through the addition corresponds to the time when the sheet leaves the nip region R1 (hereinafter referred to as “leaving time”). The time added here corresponds to the time period until the rear end of the sheet transported at this transport speed leaves the nip region R1. The controller 110 determines that a sheet is passing through the nip region R1 (YES in step S13) if the current time is in the range from the arrival time to the leaving time, and determines that no sheet is passing through the nip region R1 (NO in step S13) if the current time is not in the range. In this way, the controller 110 performs determination in accordance with a sensing result obtained from the sheet sensor 21, and thereby the sheet sensor 21 and the controller 110 function as a determining unit that determines whether or not the current state is a passing state.

If the controller 110 performs a positive determination in step S13, the controller 110 controls the exciting circuit 721 to supply a certain amount of current to the exciting coil 722 in step S14. By supplying the current, the controller 110 causes the IH heater 72 to generate an alternating-current magnetic field of a predetermined intensity. The intensity is determined in accordance with the rotation speed of the fixing belt 731 so that the fixing belt 731 is heated to the above-described fixing temperature until the fixing belt 731 passes through the heating range Y illustrated in FIG. 4. Hereinafter, such intensity is referred to as “fixing intensity”. The amount of current supplied by the exiting circuit 721 to the exciting coil 722 when the IH heater 72 generates an alternating-current magnetic field having the fixing intensity is referred to as an “amount of fixing current”. That is, the amount of current supplied in step S14 is determined to be the amount of fixing current. After step S14, the controller 110 performs step S13 again, and repeats the process until a negative determination is performed in step S13.

If the controller 110 performs a negative determination in step S13, the controller 110 controls the exciting circuit 721 so that no current is supplied to the exciting coil 722 in step S15. In step S16, the controller 110 counts the number of sheets that have passed through the nip region R1 since it was determined in step S11 that an image formation request has been received. For example, the controller 110 stores in advance data representing the value “0” in the storage section 150, increments the value by one to update the data every time step S16 is performed, and counts the number represented by the data as the number of sheets that have passed through the nip region R1. In step S17, the controller 110 determines whether or not the image formation requested in step S11 has ended. Specifically, the controller 110 determines that the image formation has ended (YES) if the number of sheets counted in step S16 has reached the number of the plural images represented by the image data supplied in step S11, and determines that the image formation has not ended (NO) if the number of sheets has not reached the number of the plural images.

If a negative determination is performed in step S17, the controller 110 performs step S13 again. Accordingly, an image is fixed onto the next sheet that reaches the nip region R1. If a positive determination is performed in step S17, the controller 110 performs step S11 again. Accordingly, the image formation requested in step S11 ends. As described above, the controller 110 performs steps S13 to S15. Accordingly, in a case where plural sheets on which images have been formed intermittently pass through the nip region R1, a current corresponding to the amount of fixing current is supplied to the exciting coil 722, and the IH heater 72 generates an alternating-current magnetic field over a time period in which the controller 110 determines that the current state is the passing state. In contrast, over a time period in which the controller 110 determines that the current state is not the passing state, no current is supplied to the excising coil 722, and the IH heater 72 does not generate an alternating-current magnetic field. The IH heater 72 and the controller 110 operate in conjunction with each other in this way, and thereby function as a “magnetic field generating unit” according to an exemplary embodiment of the invention.

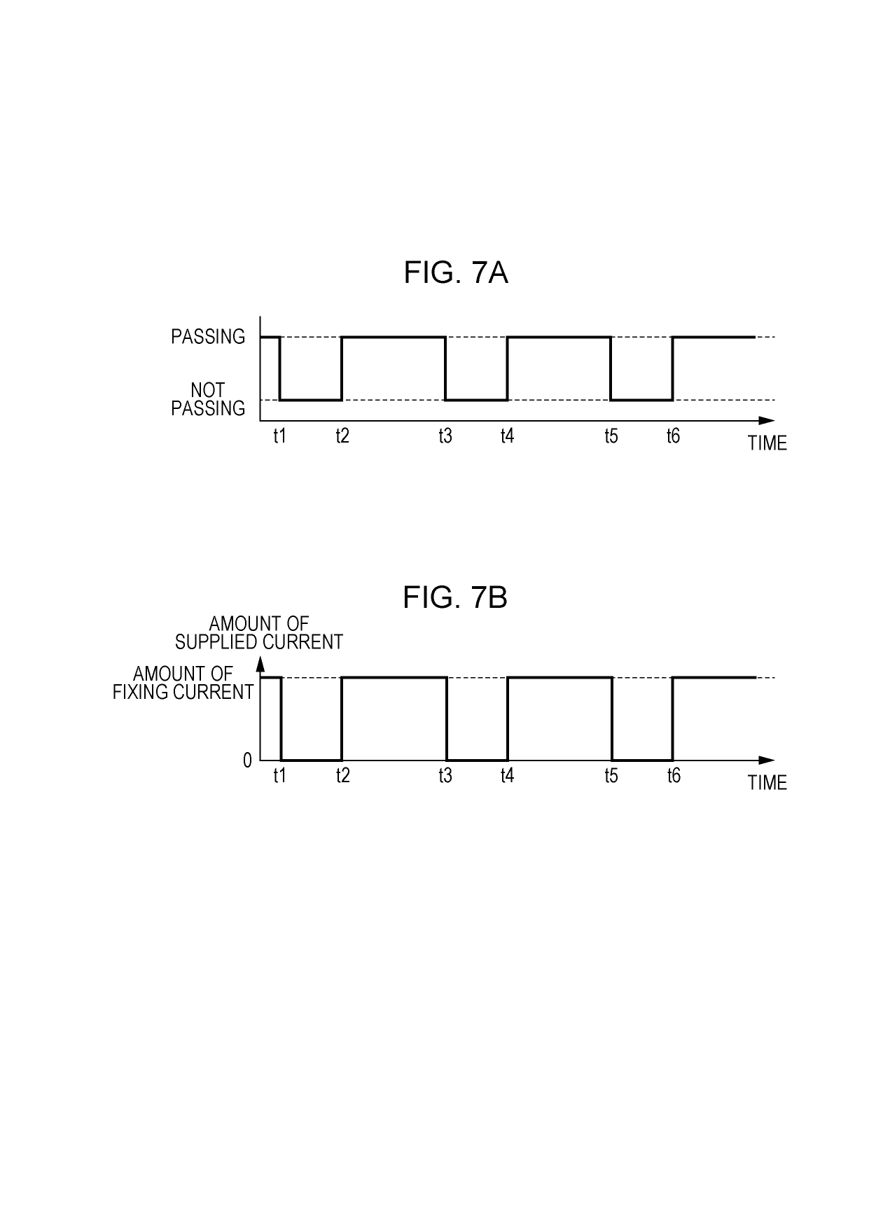

FIGS. 7A and 7B are graphs illustrating an example of timings at which a sheet passes through the nip region R1 (sheet passing timings) and the amount of current supplied to the exciting coil 722 (the amount of supplied current) in the above-described fixing process. In the graph in FIG. 7A, the vertical axis indicates whether or not a sheet is passing or not passing, and the horizontal axis indicates time. In this example, times t1, t3, and t5 are times when a sheet leaves the nip region R1, and times t2, t4, and t6 are times when a sheet reaches the nip region R1. That is, in the time range shown in this example, the period from time t1 to time t2, the period from time t3 to time t4, and the period from time t5 to time t6 are periods of a non-passing state (hereinafter referred to as “non-passing periods”), whereas the period until time t1, the period from time t2 to time t3, the period from time t4 to time t5, and the period after time t6 are periods of a passing state (hereinafter referred to as “passing periods”).

The graph in FIG. 7B shows the relationship between the amount of supplied current and time. In this graph, the vertical axis indicates the amount of supplied current, and the horizontal axis indicates time. In this example, the amount of supplied current is equal to the amount of fixing current in the passing periods, and is zero in the non-passing periods. The time period from when a current is supplied to the exciting coil 722 to when the temperature of the fixing belt 731 increases to reach the fixing temperature due to electromagnetic induction heating after an alternating-current magnetic field has been generated depends on the intensity and frequency of the alternating-current magnetic field generated by the IH heater 72 and the heat capacity of the conductive heat-generating layer 731b included in the fixing belt 731, and becomes particularly shorter as the heat capacity decreases. The time period until the portion of the fixing belt 731 which has been heated in the heating range Y illustrated in FIG. 4 reaches the nip region R1 depends on the distance from the heating range Y to the nip region R1 along the outer surface of the fixing belt 731, and the rotation speed of the fixing belt 731. In the first exemplary embodiment, the heat capacity of the conductive heat-generating layer 731b is small and the foregoing distance along the outer surface is short so that the sum of the above-descried periods is sufficiently short with respect to a passing period and a non-passing period.

In the first exemplary embodiment, the controller 110 performs control so that no current is supplied to the exciting coil 722 in a non-passing period. Accordingly, an alternating-current magnetic filed is not generated and thus the fixing belt 731 is not heated in this period. On the other hand, in the configuration of supplying a current corresponding to the amount of fixing current in a non-passing period (first comparative configuration), an alternating-current magnetic field having a fixing intensity is continuously generated to heat the fixing belt 731 even in the non-passing period. That is, according to the first exemplary embodiment, heating is not performed in a non-passing period (period in which fixing is not performed), and accordingly the amount of heat generated in this period is smaller than in the first comparative configuration. Also, the amount of power consumption in this period is smaller than in the first comparative configuration.

An exemplary embodiment of the invention is more effective in the case of using a flexible fixing belt such as the fixing belt 731 according to the first exemplary embodiment in a fixing device, compared to the case of using a rigid roller base material for a fixing member or the case of heating the entire fixing member by using an IH heater or a halogen lamp. Heat responsiveness deteriorates when a rigid roller base material having a large heat capacity is used, and heat energy is dispersed over the entire fixing member when the entire fixing member is heated. In contrast, when a flexible fixing belt is used as a fixing member to decrease heat capacity, heat responsiveness is improved compared to the above-described cases, and temperature may be quickly increased to the temperature necessary for fixing toner onto a sheet. Alternatively, part of the fixing member may be locally heated to concentrate heat energy. In any case, it is appropriate to improve heat responsiveness so that temperature may be quickly increased to the temperature necessary for fixing toner onto a sheet. The heat capacity of the fixing member may be 45 joule per kelvin (J/K) or less.

### Second Exemplary Embodiment

An image forming apparatus according to a second exemplary embodiment of the invention has the same configuration as that of the image forming apparatus 100 according to the first exemplary embodiment. Thus, the same elements as those in the first exemplary embodiment are denoted by the same reference numerals, and the corresponding description is omitted. In the first exemplary embodiment, the controller 110 performs control so that no current is supplied to the exciting coil 722 in a non-passing period. The second exemplary embodiment is different from the first exemplary embodiment in that a current is supplied to the exciting coil 722 and the IH heater 72 generates an alternating-current magnetic field even in a non-passing period. As described above, an alternating-current magnetic field having a fixing intensity is generated in a passing period. Hereinafter, the fixing intensity is referred to as a first intensity, and the intensity of an alternating-current magnetic field generated by the IH heater 72 in a non-passing period is referred to as a second intensity.

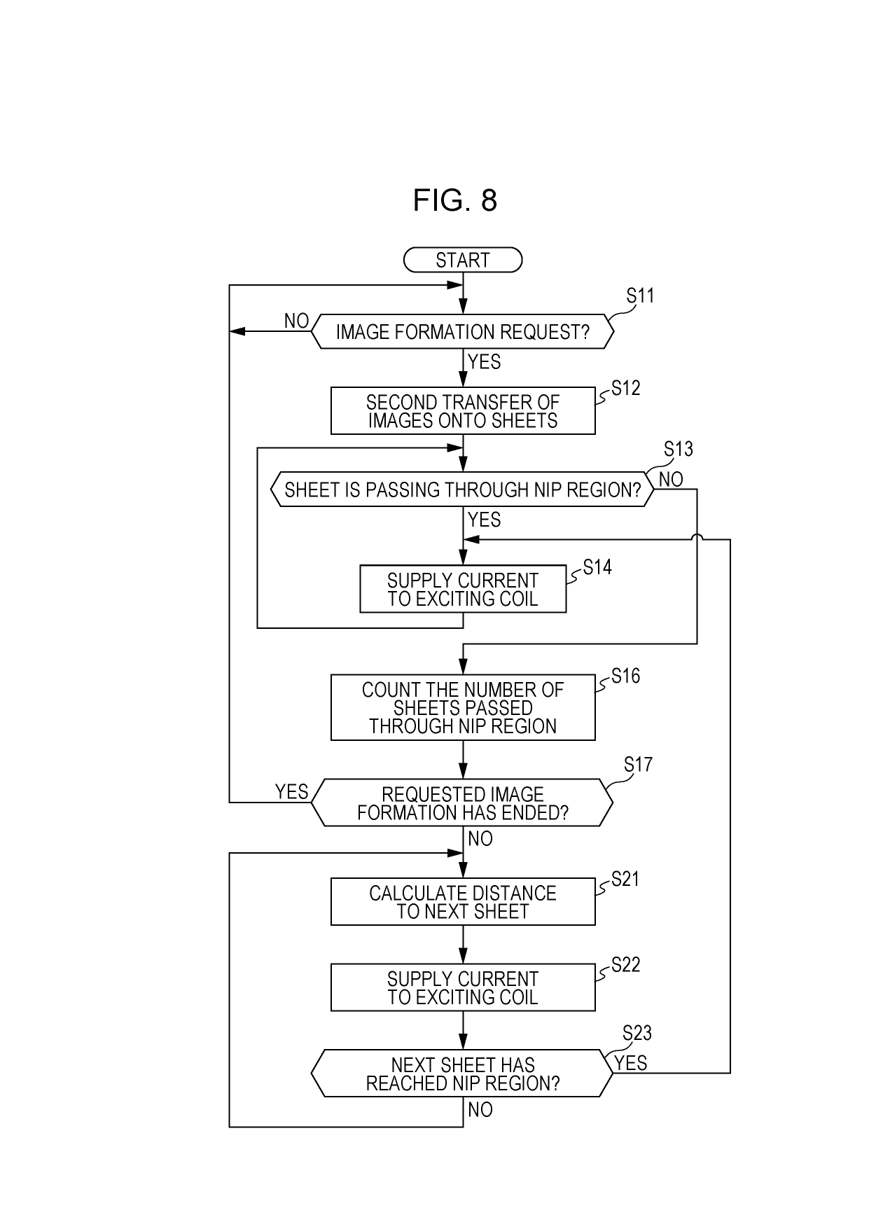

FIG. 8 is a flowchart illustrating a procedure of a fixing process according to the second exemplary embodiment. In this process, the controller 110 first performs steps S11 to S14 illustrated in FIG. 6. If it is determined in step S13 that a sheet is not passing (NO), the controller 110 performs steps S16 and S17. If it is determined in step S17 that image formation has not ended (NO), the controller 110 calculates the distance along the transport path B1 between the nip region R1 and the next sheet that is to reach the nip region R1 (hereinafter referred to as a “distance to the next sheet”) in step S21. Specifically, the controller 110 first obtains the front end sensing time described above regarding step S13, and then calculates an arrival time.

Subsequently, the controller 110 divides the first distance by the time period from the front end sensing time to the arrival time, and multiplies the value obtained through the division by the time period from the current time to the arrival time. Such calculation is expressed by the following expression (1) when the front end sensing time is represented by ta1, the arrival time is represented by ta2, the current time is represented by ta3, the first distance is represented by L1, and the distance to the next sheet is represented by L2.

L2=L1÷(ta2−ta1)×(ta2−ta3) (1)

The controller 110 calculates L2 in this manner, and thereby the distance to the next sheet (L2) is detected. In this way, the controller 110 and the sheet sensor 21 operate in conjunction with each other to function as a detecting unit that detects the distance between the nip region R1 and the next sheet that is to pass through the nip region R1 among transported sheets, that is, the distance to the next sheet.

In step S22, the controller 110 supplies a current, the amount of which corresponds to the distance to the next sheet calculated in step S21, to the exciting coil 22.

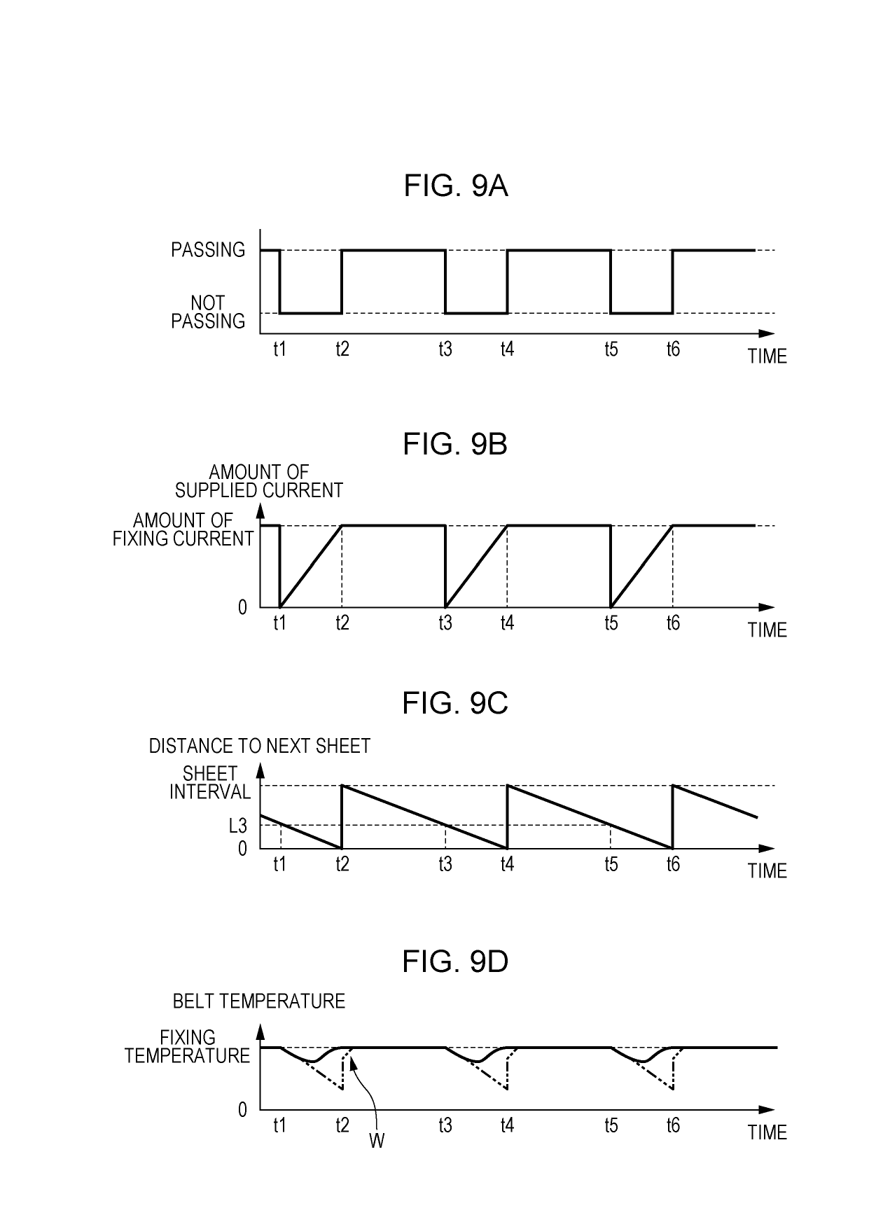

FIGS. 9A to 9D are diagrams illustrating the amount of current supplied to the exciting coil 722 in step S22. FIG. 9A illustrates a graph showing the sheet passing timings, which are the same as those illustrated in FIG. 7A. FIG. 9B illustrates, like FIG. 7B, a graph showing an example of the relationship between the amount of supplied current and time. In this example, the controller 110 changes the amount of supplied current from the amount of fixing current to zero at the time of transition from a passing period to a non-passing period, for example, at time t1. The controller 110 increases the amount of supplied current at a certain pace so that the amount of supplied current, which is zero at time t1, becomes equal to the amount of fixing current at time t2 when a passing period begins (so that the amount of change per unit time is a certain value). Accordingly, the IH heater 72 generates an alternating-current magnetic field while increasing the second intensity over the time period from time t1 to time t2, that is, over the time period until the distance to the next sheet becomes zero. The controller 110 increases the amount of supplied current in this way also in the other non-passing periods.

FIG. 9C illustrates a graph showing the relationship between the distance to the next sheet and time. The distance to the next sheet decreases at a certain pace as the sheet approaches the nip region R1, and becomes zero when the sheet reaches the nip region R1. When the distance to the next sheet becomes zero, the sheet representing the distance is changed to the next sheet which is to reach the nip region R1. When the sheet is changed, that is, at times t2, t4, and t6, the distance to the next sheet represents the interval of sheets (the interval of transported sheets). The controller 110 controls the individual units so that the sheet intervals are constant, in the case of intermittently transporting plural sheets of a certain size to form plural images represented by the above-described image data. Accordingly, the individual sheets are arranged at regular intervals, and thus the position of the front end of the next sheet when a certain sheet reaches the nip region R1 is constant. In this example, the distance to the next sheet is L3 at times t1, t3, and t5. Therefore, when the amount of fixing current is represented by E1 and when the amount of supplied current from time t1 to time t2 is represented by E2, E2 is calculated by using the following expression (2) by using the distances to the next sheet L2 and L3.

E2=E1−E1×L3÷L2 (2)

When the controller 110 calculates the distance to a certain next sheet in step S21 for the first time, the controller 110 stores the calculated distance as the distance to the next sheet L3 in the storage section 150. Subsequently, in step S22, the controller 110 calculates the amount of supplied current E2 by using expression (2) by using the distance to the next sheet L2 calculated in step S21. Then, the controller 110 supplies a current corresponding to the amount of supplied current E2 to the exciting coil 722. In this way, the controller 110 supplies the exciting coil 722 with a current the amount of which corresponds to the distance to the next sheet calculated in step S21, as described above.

In step S23, the controller 110 determines whether or not the next sheet has reached the nip region R1. For example, the controller 110 determines that the next sheet has reached the nip region R1 (YES) if the distance to the next sheet calculated in step S21 is zero, and determines that the next sheet has not reached the nip region R1 (NO) if the distance to the next sheet is longer than zero. If a negative determination is performed in step S23, the controller 110 performs step S21 again, and performs the process from step S21 to step S23 until a positive determination is performed in step S23. Accordingly, a current the amount of which corresponds to the distance to the next sheet is supplied to the exciting coil 722 until the next sheet reaches the nip region R1, that is, in a non-passing period. If a positive determination is performed in step S23, the controller 110 performs step S14. Accordingly, when a passing period comes after a non-passing period ends, a current corresponding to the amount of fixing current is supplied to the exciting coil 722, and fixing at the fixing temperature is performed.

FIG. 9D illustrates a graph showing the relationship between time and the temperature of the fixing belt 731 (belt temperature) which is measured by the temperature sensors 75 illustrated in FIG. 4 and so forth. In this graph, the vertical axis indicates the belt temperature, and the horizontal axis indicates time. In this graph, the belt temperature according to the second exemplary embodiment is represented by a solid line, and the belt temperature according to a second comparative configuration, in which no current is supplied to the exciting coil 722 from the start to the end of a non-passing period as in the first exemplary embodiment, is represented by a double-dotted chain line. In the second comparative configuration, electromagnetic induction heating is not performed in a non-passing period. Thus, the belt temperature decreases at a certain pace from time t1, and instantly increases at time t2, when electromagnetic induction heating starts. At this time, in the second comparative configuration, the belt temperature has not reached the fixing temperature at the beginning of the passing period, as represented by a W portion in the graph. The W portion indicates that unevenness of the belt temperature in the rotation direction A5 occurs in the fixing belt 731. Such unevenness occurs for the following reason. In the second comparative configuration, a current corresponding to the amount of fixing current is instantly supplied to the exciting coil 722 at time t2. As a result, a time period in which the downstream side in the rotation direction A5 of the portion in the heating range Y of the fixing belt 731 is heated is shorter than a time period in which the upstream side thereof is heated. Thus, unevenness of the belt temperature occurs in the rotation direction A5, in which the belt temperature on the downstream side is lower than the belt temperature on the upstream side. The unevenness disappears when this portion is heated next time. However, when this portion is positioned in the nip region R1 before the unevenness disappears, the belt temperature may change in the manner represented by the W portion. In this case, unevenness of the fixing ratio in the transport direction A2 may occur in an image fixed onto a sheet.

In the second exemplary embodiment, electromagnetic induction heating once stops at time t1, but electromagnetic induction heating is performed thereafter even in a non-passing period. Thus, the belt temperature once decreases after time t1 but increases before time t2 comes, and reaches the fixing temperature at time t2. In the second comparative configuration, the amount of supplied current is instantly changed from zero to the amount of fixing current. In the second exemplary embodiment, the amount of supplied current is gradually increased from zero to the amount of fixing current. Thus, the intensity of the alternating-current magnetic field generated by the IH heater 72 gradually increases to reach the fixing intensity. In this way, according to the second exemplary embodiment, the belt temperature gradually increases to reach the fixing temperature, as illustrated in FIG. 9D, and unevenness of the belt temperature, an example of which is represented by the W portion, is smaller than in the second comparative configuration. Accordingly, in the second exemplary embodiment, unevenness of the fixing ratio in the transport direction A2 is smaller than in the second comparative configuration.

### Third Exemplary Embodiment

An image forming apparatus according to a third exemplary embodiment of the invention has the same configuration as that of the image forming apparatus 100 according to the first exemplary embodiment. Thus, the same elements as those in the first exemplary embodiment are denoted by the same reference numerals, and the corresponding description is omitted. The third exemplary embodiment is the same as the second exemplary embodiment in that the controller 110 supplies a current to the exciting coil 722 even in a non-passing period, and in that a fixing process is performed in accordance with the procedure illustrated in the flowchart in FIG. 8. The third exemplary embodiment is different from the second exemplary embodiment in the method for calculating an amount of current in accordance with the distance to the next sheet in step S22.

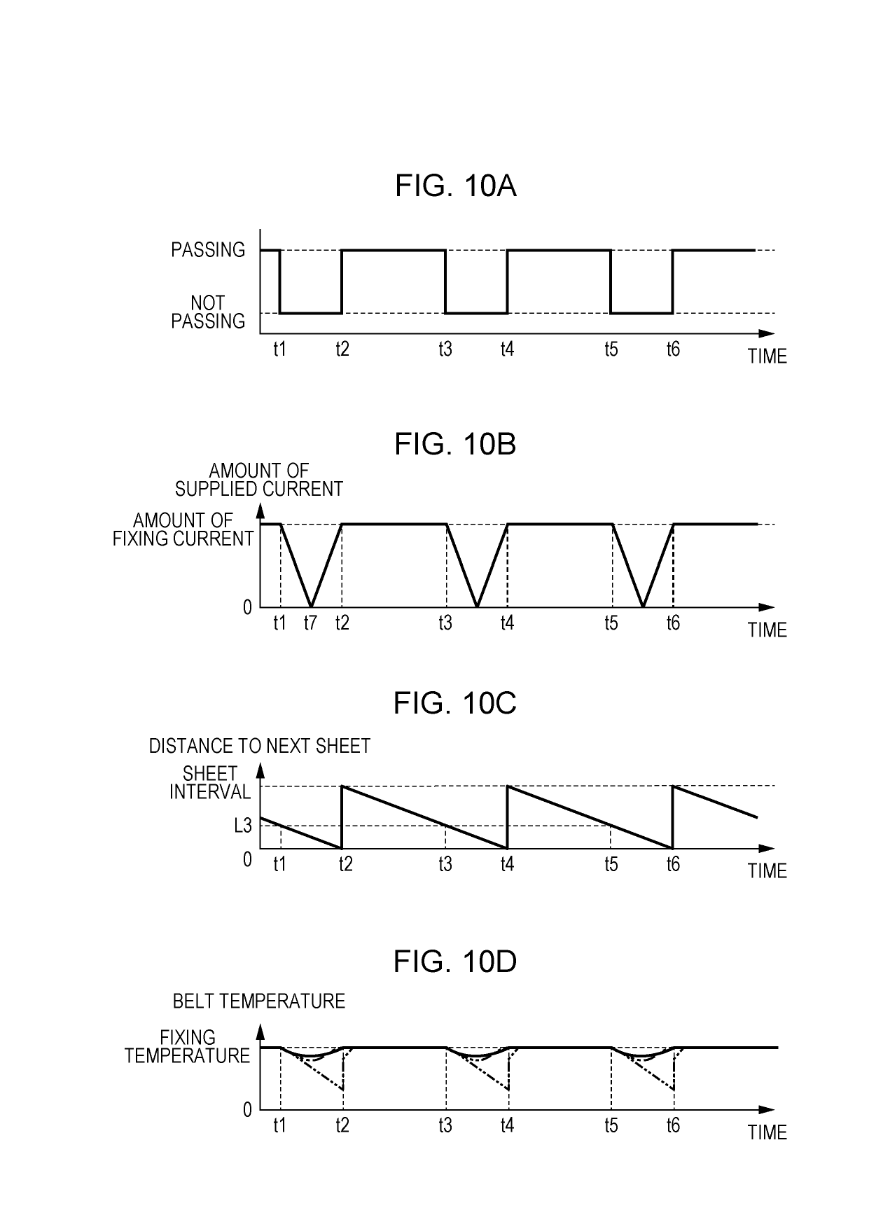

FIGS. 10A to 10D are diagrams illustrating the amount of current supplied to the exciting coil 722 in step S22 in the third exemplary embodiment. FIGS. 10A and 10C illustrate the graphs that are the same as the graphs illustrated in FIGS. 9A and 9C. FIG. 10B illustrates, like FIG. 9B, a graph showing an example of the relationship between the amount of supplied current and time. In this example, the controller 110 gradually decreases the amount of supplied current at a certain pace from time t1, and gradually increases the amount of supplied current at a certain pace from time t7, which is the midpoint between times t1 and t2, to time t2. At this time, the controller 110 increases and decreases the amount of supplied current so that the amount becomes zero at time t7 and becomes equal to the amount of fixing current at time t2. The controller 110 increases and decreases the amount of supplied current in this manner also in the other non-passing periods. In this case, when the amount of supplied current from time t1 to time t7 is represented by E3, the controller 110 calculates E3 in accordance with the following expression (3) by using the above-described distances to the next sheet L2 and L3. When the amount of supplied current from time t7 to time t2 is represented by E4, the controller 110 calculates E4 in accordance with the following expression (4).

$$\begin{matrix}E 3 = E 1 \div \frac{L 3}{2} \times \{ \frac{L 3}{2} - ( L 3 - L 2 ) \} = \frac{2 \times E 1 \times L 2}{L 3} - E 1 & ( 3 ) \\ E 4 = E 1 \div \frac{L 3}{2} \times \{ \frac{L 3}{2} - L 2 \} = E 1 - \frac{2 \times E 1 \times L 2}{L 3} & ( 4 )\end{matrix}$$

In this way, the controller 110 supplies the exciting coil 722 with a current the amount of which corresponds to the distance to the next sheet calculated in step S21, as described above. FIG. 10D illustrates, like FIG. 9D, a graph showing the relationship between the belt temperature and time. In this graph, the belt temperature according to the third exemplary embodiment is represented by a solid line, and the belt temperature according to a third comparative configuration, in which the amount of supplied current is controlled in the same manner as in the second comparative configuration and the second exemplary embodiment, is represented by a double-dotted chain line. In the third exemplary embodiment, the amount of supplied current is gradually decreased from time t1 to time t7, and thus the belt temperature gradually decreases compared to the second and third comparative configurations. For example, when the amount of supplied current is changed from the amount of fixing current to zero at time t1, a difference in temperature occurs between a portion which is located in the heating range Y and is heated at the time and a portion which is located just before the heating range Y and has the lowest temperature. The difference in temperature disappears when heating is continued until the belt temperature increases to reach the fixing temperature. However, the portion having unevenness may be located in the nip region R1 before the difference in temperature disappears. In this case, unevenness of the fixing ratio in the transport direction A2 may occur also in an image fixed onto a sheet. In the third exemplary embodiment, heating is not stopped at time t1, but the amount of supplied current, that is, the degree of heating, is gradually decreased from time t1. Accordingly, the belt temperature gradually decreases, and the above-described difference in temperature, that is, unevenness of the temperature, becomes small. As described above, according to the third exemplary embodiment, unevenness of the ratio of fixing an image onto a sheet in the transport direction A2 is smaller than in the second and third comparative configurations.

### Fourth Exemplary Embodiment

An image forming apparatus according to a fourth exemplary embodiment of the invention has the same configuration as that of the image forming apparatus 100 according to the first exemplary embodiment. Thus, the same elements as those in the first exemplary embodiment are denoted by the same reference numerals, and the corresponding description is omitted. The fourth exemplary embodiment is the same as the second and third exemplary embodiments in that the controller 110 supplies a current to the exciting coil 722 even in a non-passing period, and in that a fixing process is performed in accordance with the procedure illustrated in the flowchart in FIG. 8. The fourth exemplary embodiment is different from the second and third exemplary embodiments in the method for calculating an amount of current in accordance with the distance to the next sheet in step S22.

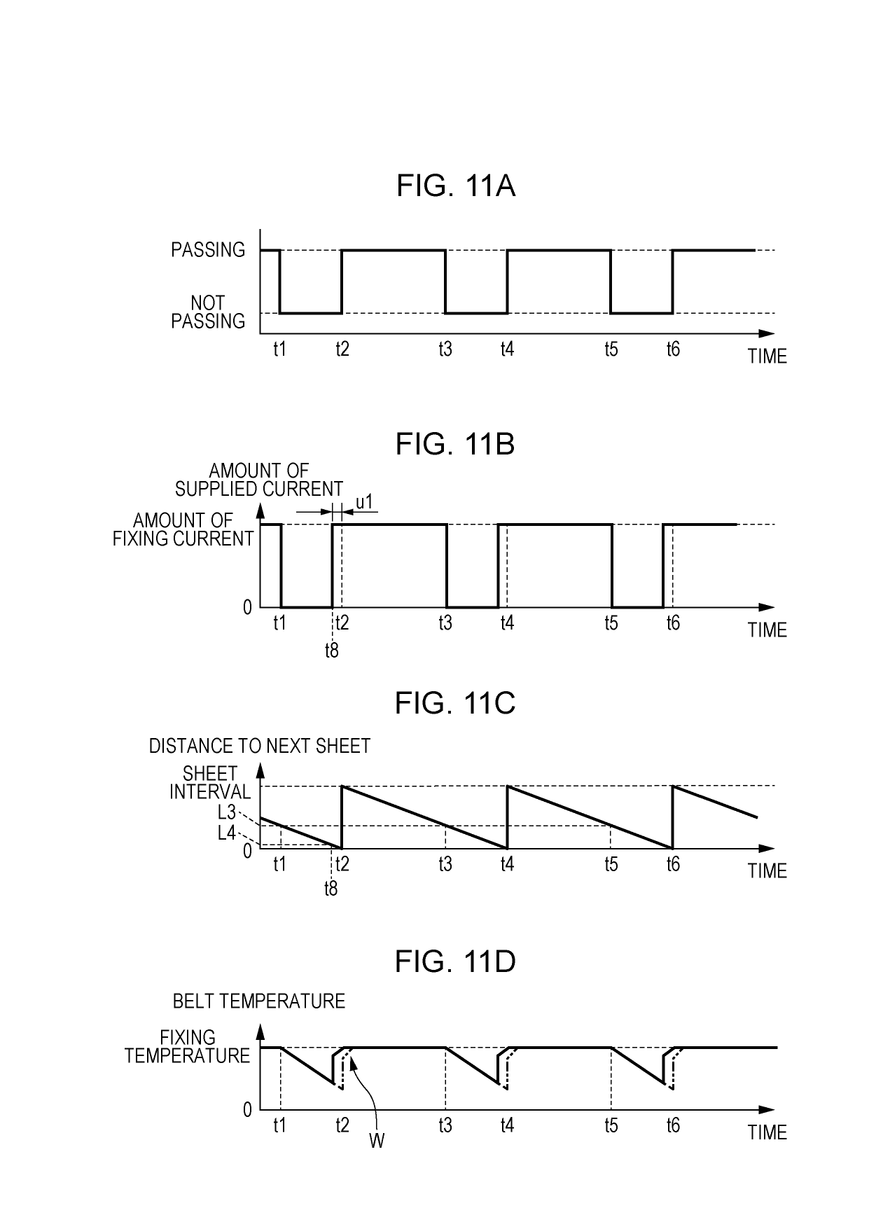

FIGS. 11A to 11D are diagrams illustrating the amount of current supplied to the exciting coil 722 in step S22 in the fourth exemplary embodiment. FIGS. 11A and 11C illustrate the graphs that are the same as the graphs illustrated in FIGS. 9A and 9C. FIG. 11B illustrates, like FIG. 9B, a graph showing an example of the relationship between the amount of supplied current and time. In this example, the controller 110 changes the amount of supplied current to zero at time t1, and changes the amount of supplied current to the amount of fixing current at time t8, which is before time t2 by a time period u1. The controller 110 increases the amount of supplied current in this manner also in the other non-passing periods. The distance to the next sheet at time t8 is represented by L4. In this case, if the distance to the next sheet calculated in step S21 is longer than L4, the controller 110 supplies no current in step S22. If the distance to the next sheet is equal to or shorter than L4, the controller 110 supplies a current corresponding to the amount of fixing current. In this way, the controller 110 supplies the exciting coil 722 with a current the amount of which corresponds to the distance to the next sheet.

FIG. 11D illustrates, like FIG. 9D, a graph showing the relationship between the belt temperature and time. In this graph, the belt temperature according to the fourth exemplary embodiment is represented by a solid line, and the belt temperature according to the second comparative configuration is represented by a double-dotted chain line. In the fourth exemplary embodiment, a current corresponding to the amount of fixing current is supplied at the time earlier than time t2 by the time period u1. Thus, even if there is a portion where the belt temperature has not reached the fixing temperature, as represented by the W portion, such a portion appears at time t8. Then, continuous heating after time t8 causes the belt temperature to be increased to the fixing temperature until the time period u1 has elapsed. In the fourth exemplary embodiment, the controller 110 does not increase and decrease the amount of supplied current in the manner described above in the second and third exemplary embodiments. That is, according the fourth exemplary embodiment, even if the controller 110 is incapable of performing control to increase and decrease the amount of supplied current, unevenness of the belt temperature in the rotation direction A5 is smaller than in the second comparative configuration, and as a result, unevenness of the ratio of fixing an image onto a sheet in the transport direction A2 is smaller than in the second comparative configuration.

### Conclusion of Exemplary Embodiments

In each of the above-described exemplary embodiments, the controller 110 of the image forming apparatus 100 realizes the following functions by executing a program.

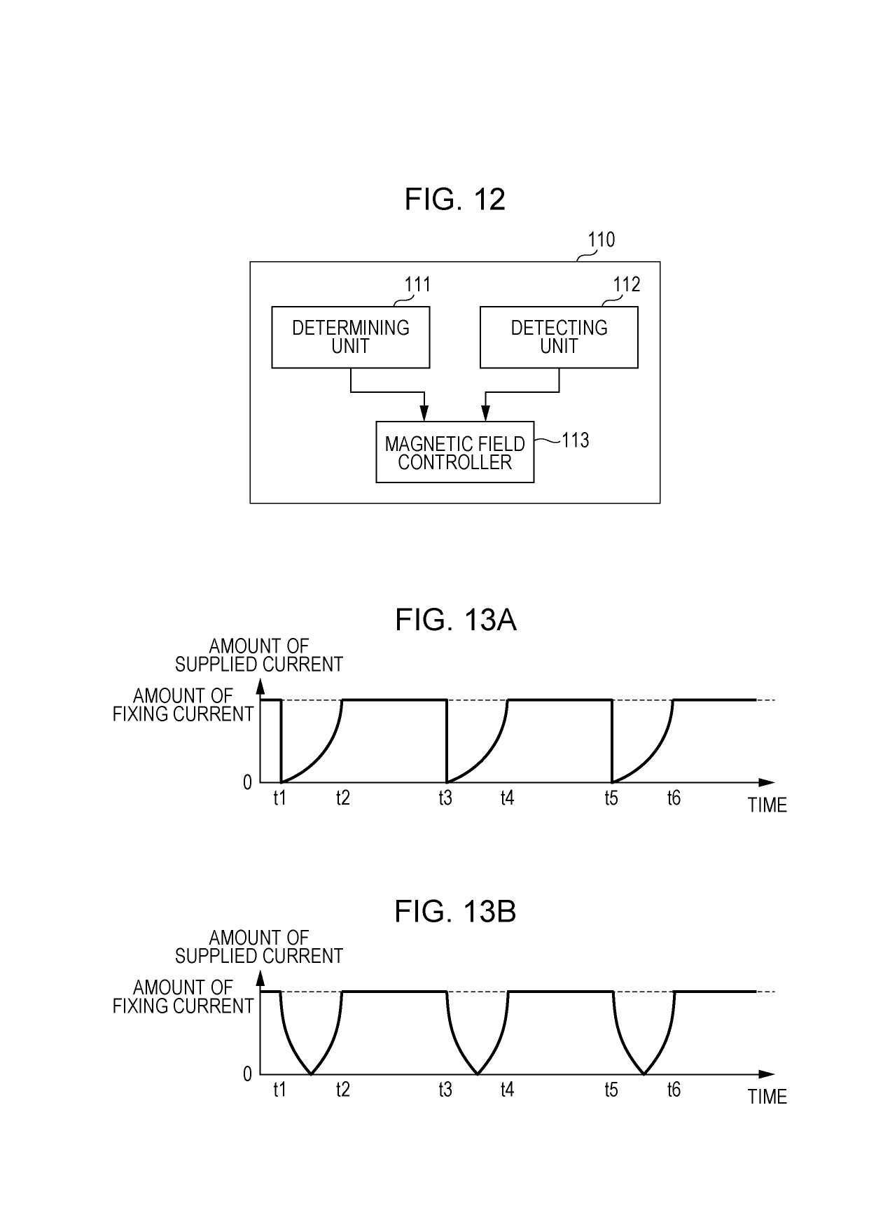

FIG. 12 is a functional block diagram illustrating the functions realized by the controller 110. The controller 110 includes a determining unit 111, a detecting unit 112, and a magnetic field controller 113. The determining unit 111 performs step S13 illustrated in FIGS. 6 and 8, and thereby determines whether or not the current state is a passing state. The determining unit 111 supplies data representing the determination result to the magnetic field controller 113. The detecting unit 112 performs step S21 illustrated in FIG. 8, and thereby detects the distance between the nip region R1 and the next sheet that is to reach the nip region R1. The detecting unit 112 supplies data representing the detection result to the magnetic field controller 113.

In the first exemplary embodiment, the magnetic field controller 113 performs steps S14 and S15 illustrated in FIG. 6, and thereby controls the IH heater 72 so that an alternating-current magnetic field having the first intensity is generated over a period in which the determining unit 111 determines that the current state is the passing state, and so that an alternating-current magnetic field having the second intensity, which is lower than the first intensity, is generated or an alternating-current magnetic field is not generated over a period in which the determining unit 111 determines that the current state is not the passing state. In the second exemplary embodiment, the magnetic field controller 113 performs steps S14, S21, S22, and S23 illustrated in FIG. 8, and thereby generates an alternating-current magnetic field while increasing the second intensity from when the distance detected by the detecting unit 112 becomes shorter than a threshold to when the distance becomes zero. In the third exemplary embodiment, the magnetic field controller 113 performs these steps illustrated in FIG. 8, and thereby generates an alternating-current magnetic field while decreasing the second intensity from when the determining unit 111 determines that the current state is not the passing state to when the distance detected by the detecting unit 112 becomes shorter than the threshold. In the fourth exemplary embodiment, the magnetic field controller 113 performs these steps illustrated in FIG. 8, and thereby generates an alternating-current magnetic field having the first intensity when the distance detected by the detecting unit 112 becomes shorter than the threshold in a period when the determining unit 111 determines that the current state is not the passing state.

### MODIFICATION EXAMPLES

The above-described exemplary embodiments are merely examples of an embodiment of the invention, and may be modified in the following manner. Also, the above-described exemplary embodiments and the following modification examples may be combined according to necessity.

### First Modification Example

In each of the above-described exemplary embodiments, the controller 110 determines in step S13 whether or not the current state is the passing state. Alternatively, the controller 110 may determine whether or not the current state is a state where an image formed on a sheet is passing through the nip region R1. In this case, the image forming apparatus 100 includes an image sensor 22 represented by a broken line in FIG. 2. The image sensor 22 is used for sensing whether or not there is an image on a sheet passing through a certain position along the transport path B1. Hereinafter, a position where the image sensor 22 senses whether or not there is an image will be referred to as an “image sensing position”. The image sensor 22 is disposed so that the image sensing position is in the range from the transfer region of the transport path B1 to the fixing device 7, and is disposed on the side opposite to the sheet sensor 21 with the transport path B1 interposed therebetween. The image sensor 22 is an optical sensor or the like, emits light to the image sensing position, and receives light from the image sensing position. The intensity of the light received by the image sensor 22 varies depending on whether or not there is an image at the image sensing position. For example, it is determined that there is an image at the image sensing position when the intensity is lower than a certain threshold, and it is determined that there is no image at the image sensing position when the intensity is equal to or higher than the certain threshold. The image sensor 22 supplies sensing data representing the sensing result to the controller 110. The sensing data is data representing the intensity of received light, for example. The controller 110 determines that there is an image at the image sensing position when the intensity represented by the sensing data is lower than the foregoing threshold, and determines that there is no image at the image sensing position when the intensity represented by the sensing data is equal to or higher than the threshold.

The controller 110 determines, in step S13 illustrated in FIG. 6 and so forth, whether or not the current state is a state where an image is passing through the nip region R1. The controller 110 performs the determination in step S13 by using the sensing data supplied from the image sensor 22, instead of using the sensing data supplied from the sheet sensor 21. In the other steps, the controller 110 performs the same process as that in the above-described exemplary embodiments, so that the amount of supplied current in a period when an image is not passing through the nip region R1 is smaller than that in the first comparative configuration. The size of an image in the transport direction A2 is often smaller than the size of the sheet on which the image is formed in the transport direction A2. In this case, a period in which an image is not passing through the nip region R1 is longer than a period in which a sheet is not passing through the nip region R1. That is, according to the first modification example, the amount of current used for fixing is small compared to the case of controlling the amount of supplied current in accordance with a determination whether or not the current state is a state where a sheet is passing through the nip region R1 as in the above-described exemplary embodiments.

### Second Modification Example

In the second and third exemplary embodiments, the controller 110 increases and decreases the amount of supplied current at a certain pace. The pace may be changed.

FIGS. 13A and 13B are graphs illustrating examples of the relationship between the amount of supplied current and time according to a second modification example. FIG. 13A illustrates a case where the pace of increasing the amount of supplied current is low at first and is gradually increased in the second exemplary embodiment. FIG. 13B illustrates a case where the pace of decreasing the amount of supplied current is high at first and is gradually decreased, and the pace of increasing the amount of supplied current is changed in the manner illustrated in FIG. 13A, in the third exemplary embodiment. In these examples, the amount of power consumption in a non-passing period is small compared to the case of increasing and decreasing the amount of supplied current without changing the certain pace. Also in this case, as a result of gradually increasing and decreasing the amount of supplied current, the belt temperature gradually decreases from the fixing temperature or gradually increases to reach the fixing temperature. Accordingly, compared to the second comparative configuration, unevenness of the belt temperature in the rotation direction A5 reduces, and unevenness of the fixing ratio in the transport direction A2 reduces.

### Third Modification Example

In the second exemplary embodiment, for example, in the first non-passing period among the non-passing periods illustrated in FIG. 9B, the controller 110 starts increasing the amount of supplied current from time t1, and thereby starts increasing the second intensity, which is the intensity of an alternating-current magnetic field in a non-passing period. Alternatively, the controller 110 may start increasing the amount of supplied current and the second intensity at another time in the non-passing period, not at time t1. That is, the controller 110 may control the individual units so that an alternating-current magnetic field is generated with the second intensity being increased from when the distance calculated in step S21 becomes shorter than the threshold to when the distance becomes zero. This distance is detected by the detecting unit (controller 110 and sheet detector 21) described above regarding step S21. Current may be supplied to the exiting coil 722 also before the distance becomes shorter than the threshold. The amount of supplied current may not become zero when the distance becomes shorter than the threshold. Even in these cases, the intensity of the alternating-current magnetic field generated by the IH heater 72 gradually increases to reach the fixing intensity by gradually increasing the amount of supplied current to the amount of fixing current by the controller 110. Thus, the belt temperature gradually increases to reach the fixing temperature though the timing to start increasing is later compared to the case illustrated in FIG. 9D. Accordingly, unevenness of the belt temperature in the rotation direction A5 reduces, and unevenness of the fixing ratio in the transport direction A2 reduces, compared to the second comparative configuration.

### Fourth Modification Example

In the third exemplary embodiment, for example, in the first non-passing period among the non-passing periods illustrated in FIG. 10B, the controller 110 decreases the amount of supplied current from time t1 to time t7 and then increases the amount of supplied current from time t7. Alternatively, the controller 110 may not increase the amount of supplied current. Even in this case, unevenness of the fixing ratio which is based on a difference in temperature caused on the upstream side in the rotation direction A5 in the heating range Y reduces, as described above.

In the foregoing example, the controller 110 continuously decreases the amount of supplied current from time t1 to time t7. Alternatively, the controller 110 may continuously decrease the amount of supplied current to a certain time other than time t7. The certain time may be any time in a non-passing period (in this example, any time after time t1 and before time t2), for example, a time at which the distance to the next sheet becomes shorter than the threshold. In this case, the controller 110 controls the individual units so that the IH heater 72 generates an alternating-current magnetic field while decreasing the second intensity from time t1 at which it is determined in step S13 that the current state is not the passing state to when the distance to the next sheet becomes shorter than the threshold. This state is determined by the determining unit described above regarding step S13.

### Fifth Modification Example

In the fourth exemplary embodiment, for example, in the first non-passing period among the non-passing periods illustrated in FIG. 11B, the controller 110 supplies a current corresponding to the amount of fixing current from time t8. Alternatively, the controller 110 may supply a current corresponding to the amount of fixing current from a time other than time t8. The time may be, for example, a time at which the distance to the next sheet becomes shorter than the threshold, as in the fourth modification example. In this case, the controller 110 controls the individual units so that the amount of supplied current is changed to zero at time t1 and an alternating-current magnetic field having the first intensity (fixing intensity) is generated when the distance to the next sheet becomes shorter than the threshold. In the time period from time t1 to when the distance to the next sheet becomes shorter than the threshold, the controller 110 may cause the amount of supplied current to be larger than zero, and may keep the amount of supplied current unchanged from a certain amount or may increase and decrease the amount of supplied current. That is, the controller 110 may perform control so that an alternating-current magnetic field having the first intensity is generated from when the distance to the next sheet becomes shorter than the threshold.

### Sixth Modification Example

In the above-described exemplary embodiments and the first modification example, the controller 110 calculates, in step S21 illustrated in FIG. 8, the distance along the transport path B1 between the nip region R1 and the next sheet which is to reach the nip region R1 or an image formed on the sheet. Alternatively, the controller 110 may calculate the distance between the nip region R1 and a sheet or image which has not reached the nip region R1, instead of the next sheet or image which is to reach the nip region R1. If the calculated distance is shorter than the threshold, the controller 110 calculates the amount of supplied current in the manner described in the above exemplary embodiments and the first modification example, and supplies the current corresponding to the calculated amount to the exciting coil 722 in step S22. When the calculated distance is shorter than the threshold, the distance is the distance to the next sheet which is to reach the nip region R1. Thus, also in the sixth modification example, a fixing process is performed in the same manner as in the above-described exemplary embodiments and the first modification example.

### Seventh Modification Example

In the above-described exemplary embodiments, the image forming apparatus 100 forms an image on a sheet. Alternatively, the image forming apparatus 100 may form an image on a sheet made of plastic, such as an overhead projection (OHP) sheet, or a sheet made of another material. That is, the image forming apparatus 100 may form an image on a medium on which an image is recordable on its surface.

### Eighth Modification Example

The fixing device may have a heat-storage plate to realize high productivity. Here, the heat-storage plate is a member made of a temperature-sensitive magnetic alloy and is disposed along the inner surface of the fixing belt 731 while being in contact therewith. The heat-storage plate is disposed in the heating range Y. The thickness and material of the heat-storage plate are adjusted so as to generate heat by using electromagnetic induction caused by an alternating-current magnetic field generated by the IH heater 72. The heat generated by the heat-storage plate is supplied to the fixing belt 731. By using such a heat-storage plate, the fixing belt 731 is heated by the heat generated by the heat-storage plate in addition to the heat generated by the fixing belt 731. Accordingly, there may be provided a fixing device capable of suppressing a decrease in temperature of the fixing belt 731 while increasing the efficiency of electromagnetic induction heating caused by the IH heater 72 and realizing high productivity.

### Ninth Modification Example

An exemplary embodiment of the invention may be grasped as a fixing device achieved by the controller 110 and the fixing device 7 which cooperate with each other, an image forming apparatus, a computer which controls the fixing device, and a program for causing the controller 110 to perform the process illustrated in FIG. 6 or FIG. 8. The program may be provided in the form of a recording medium, such as an optical disc storing the program, or may be downloaded to the computer via a communication line such as the Internet and may be installed to the computer so that the program is available.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A fixing device comprising:
a first rotation member that rotates around a first axis;
a fixing member that includes a second rotation member which rotates around a second axis while being in contact with the first rotation member, the second axis extending along the first axis, and which generates heat by using electromagnetic induction in an alternating-current magnetic field, and that fixes an image onto a medium in a region where the first rotation member and the second rotation member come into contact with each other;
a determining unit that determines whether or not a current state is a certain state where the medium or an image formed on the medium is passing through the region; and
a magnetic field generating unit that generates an alternating-current magnetic field in a space including the second rotation member, and that, in a case where a plurality of media on which images have been formed intermittently pass through the region, generates an alternating-current magnetic field having a first intensity over a period in which the determining unit determines that the current state is the certain state, and generates an alternating-current magnetic field having a second intensity which is lower than the first intensity or does not generate an alternating-current magnetic field over a period in which the determining unit determines that the current state is not the certain state.

2. The fixing device according to claim 1, further comprising:
a detecting unit that detects a distance between the region and the medium or the image formed on the medium which has not reached the region,
wherein the second rotation member is an endless belt, and
wherein the magnetic field generating unit generates an alternating-current magnetic field which passes through a portion of the endless belt, and generates an alternating-current magnetic field while increasing the second intensity from when the distance detected by the detecting unit becomes shorter than a threshold to when the distance becomes zero.

3. The fixing device according to claim 1, further comprising:
a detecting unit that detects a distance between the region and the medium or the image formed on the medium which has not reached the region,
wherein the second rotation member is an endless belt, and
wherein the magnetic field generating unit generates an alternating-current magnetic field which passes through a portion of the endless belt, and generates an alternating-current magnetic field while decreasing the second intensity from when the determining unit determines that the current state is not the certain state to when the distance detected by the detecting unit becomes shorter than the threshold.

4. The fixing device according to claim 1, further comprising:
a detecting unit that detects a distance between the region and the medium or the image formed on the medium which has not reached the region,
wherein the second rotation member is an endless belt, and
wherein the magnetic field generating unit generates an alternating-current magnetic field which passes through a portion of the endless belt, and generates an alternating-current magnetic field having the first intensity when the distance detected by the detecting unit becomes shorter than the threshold in a period where the determining unit determines that the current state is not the certain state.

5. An image forming apparatus comprising:
an image forming section that forms an image on a medium;
a transport member that transports the medium on which the image has been formed by the image forming section to a region; and
the fixing device according to claim 1 that fixes the image onto the medium transported by the transport member.

6. A fixing method for a fixing device including a first rotation member that rotates around a first axis, a fixing member that includes a second rotation member which rotates around a second axis while being in contact with the first rotation member, the second axis extending along the first axis, and which generates heat by using electromagnetic induction in an alternating-current magnetic field, and that fixes an image onto a medium in a region where the first rotation member and the second rotation member come into contact with each other, a determining unit that determines whether or not a current state is a certain state where the medium or an image formed on the medium is passing through the region, and a magnetic field generating unit that generates an alternating-current magnetic field in a space including the second rotation member, the fixing method comprising:
controlling the magnetic field generating unit so that, in a case where a plurality of media on which images have been formed intermittently pass through the region, the magnetic field generating unit generates an alternating-current magnetic field having a first intensity over a period in which the determining unit determines that the current state is the certain state, and generates an alternating-current magnetic field having a second intensity which is lower than the first intensity or does not generate an alternating-current magnetic field over a period in which the determining unit determines that the current state is not the certain state.

7. A non-transitory computer readable medium storing a program causing a computer to execute a process for controlling a fixing device including a first rotation member that rotates around a first axis, a fixing member that includes a second rotation member which rotates around a second axis while being in contact with the first rotation member, the second axis extending along the first axis, and which generates heat by using electromagnetic induction in an alternating-current magnetic field, and that fixes an image onto a medium in a region where the first rotation member and the second rotation member come into contact with each other, a determining unit that determines whether or not a current state is a certain state where the medium or an image formed on the medium is passing through the region, and a magnetic field generating unit that generates an alternating-current magnetic field in a space including the second rotation member, the process comprising:
controlling the magnetic field generating unit so that, in a case where a plurality of media on which images have been formed intermittently pass through the region, the magnetic field generating unit generates an alternating-current magnetic field having a first intensity over a period in which the determining unit determines that the current state is the certain state, and generates an alternating-current magnetic field having a second intensity which is lower than the first intensity or does not generate an alternating-current magnetic field over a period in which the determining unit determines that the current state is not the certain state.
